(19) United States
(12) Patent Application Publication
(10) Pub. No.: US 2006/0185446 A1
(43) Pub. Date: Aug. 24, 2006

(54) Printed strain gage for vehicle seats

(76) Inventor: Frank H. Speckhart, Knoxville, TN (US)

Correspondence Address: PITTS AND BRITTIAN P C, P O BOX 51295, KNOXVILLE, TN, 37950-1295, US

(21) Appl. No.: 11/060,832

(22) Filed: Feb. 18, 2005

(51) Int. Cl. G01L 5/04

(52) U.S. Cl. 73/862.391

(57) ABSTRACT

An apparatus for a printed strain gauge affixed to a structural member of a seat for detecting and measuring the weight and position of an occupant or object on the seat. In various embodiments, a strain gauge is printed directly on a member of the seat that is subject to a bending force or other stress when an object is placed in the seat. The strain gauge includes at least one resister of thin-film conductive material printed on a stress bearing member. In one embodiment, the strain gauge is a resistor sensitive to the stress of said member. In another embodiment, the strain gauge is a group of resistors forming a Wheatstone bridge sensitive to the stress.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to strain gauges for measuring the seated weight of occupants of vehicle seats. More particularly, this invention pertains to a strain gauge printed onto or otherwise attached to a seat pan or other member that supports the seat cushion.

2. Description of the Related Art

A strain gauge is a sensor that deforms with an object to measure the object's strain, or deformation. The magnitude of the deformation is useful in performing stress and structural analysis of members and structures. It is also useful for indirectly obtaining some other value of interest, such as the mass of an object on the member or structure.

Typically, strain gauges have one or more resistors for which the resistance changes according to the configuration of the resistor (i.e., a sensing resistor). Four total resistors are normally linked together in a diamond configuration to form a circuit known as a Wheatstone bridge. The diamond configuration forms two separate current paths along which an input current can travel. A signal detector, such as an ammeter or voltmeter, straddles the two current paths so that a current or voltage difference between the two paths can be measured. When resistance along one path increases, current can be expected to move through the signal detector to reach the other, lower-resistance path. Such an arrangement enhances the sensitivity of the sensor because the output signal is not proportional to the absolute resistance of the sensing resistor, but is proportional to the change in resistance between the current paths.

For example, in a quarter-bridge circuit, one of the four resistors is a sensing resistor attached to the member in such a fashion that the resistor lengthens or shortens when the member deforms. The output voltage of the bridge circuit is measured to determine how far the sensing resistor is deflected. In the alternative, one of the other three resistors may be a variable resistor (i.e., a resistor with adjustable resistance). The resistance of the variable resistor is adjusted until the bridge is balanced, i.e., the resistance change of the sensing resistor has been fully compensated for so that there is no output voltage. The resistance value of the variable resistor is then be read to determine by inference the resistance of the sensing resistor.

Half-bridge and Full-bridge type circuits are also commonly used. A half-bridge circuit has two sensing resistors. The sensing resistors may be arranged in additive fashion, in which case they are both placed on the same side of the member to receive the same deformation. If the sensing resistors are placed side-by-side, the effect is to negate the influence of lateral bending on the vertical bending measurement obtained by the sensor. The sensing resistors may alternatively be arranged in subtractive fashion and positioned on opposite sides of the beam (for example, one on the top side and one on the bottom side) so that the deformation they receive is opposite. The effect of such placement is to negate axial strain such as tension or compression along the length of the beam. In such a way, a half-bridge circuit can be used to remove undesirable strain effects from the pure vertical bending output of the sensor.

Full-bridge circuits have four sensing resistors. The location of the four sensing resistors can provide multiple compensation effects simultaneously. For example, if two sensing resistors attached to the top side of the member and two placed on the bottom side of the member, both lateral bending and axial strain are filtered from the sensor output. Alternatively, if all four sensing resistors are placed on one side of the beam, the sensor provides increased compensation for lateral bending alone.

Various examples of strain gauges are known. For example, U.S. Pat. No. 6,688,185, issued to Knox, et al., on Feb. 10, 2004, titled “System and method for microstrain measurement,” discloses a microstrain sensor as a conductive film 24 with four conductors 42, 44, 52, 54 in contact with the film 24. The film 24 is screen printed thick film on an insulator 22 affixed directly to a deformable member 20. The preferred embodiment is a thick film for the film 24, which Knox, et al., states has advantages over a thin film. The conductive film 24 is a circuit equivalent of a Wheatstone bridge with four resistors 70, 72, 74, 76, although discrete resistors are not used.

U.S. Pat. No. 5,867,808, issued to Selker, et al., on Feb. 2, 1999, titled “Force transducer with screen printed strain gauges,” discloses a force transducer with an elongated lever arm attached to a thick-film resistive strain gauge material. The lever arm protrudes normal the surface of the strain gauge is forms the operator of a joystick force transducer, such as found on the keyboard of a laptop computer.

U.S. Pat. No. 6,748,814, issued to Ishida, et al., on Jun. 15, 2004, titled “Load detection structure for vehicle seat,” discloses a load detection structure 10 for a vehicle seat 24. The load detection structure 10 forms part of the load bearing structure supporting the seat 24 in the vehicle. The load detection structure 10 includes load detection means 20 that include a strain plate member 12 and a strain gauge 18. The strain plate member 12 is formed from an oblong plate spring material.

U.S. Pat. No. 6,571,647, issued to Aoki, et al. on Jun. 3, 2003, titled “Seat weight measuring apparatus,” discloses a seat weight measuring device 9 that is connected between the lower surface of the seat rails 7 and to the seat brackets 11 fixed to the vehicle body. The seat weight measuring device 9 includes a Z arm 23 that bears on a sensor plate (spring member) 51 that is securely fixed to the top of a column 63. The sensor plate 51 has an insulting layer 52, a wiring layer 53, and a resistant layer 54 that forms the strain gauge.

U.S. Pat. No. 6,394,490, issued to Osmer, et al., on May 28, 2002, titled “Vehicle occupant position detector and airbag control system,” discloses a system for detecting the location and weight of a person in a car. Connected between the seat rails 44 supporting the seat 33 and the vehicle floor 39 are four weight sensors 50. The weight sensors 50 carry and measure the weight of the seat 33 and passenger. Osmer discloses two embodiments in which each sensor 50, 80 has a cantilevered beam or base 55, 82 upon which several strain gauge resistors 60, 84 are located with interconnecting conductors 62, 86. The beam or base 55, 82 is a load carrying member providing support to the seat 33.

### BRIEF SUMMARY OF THE INVENTION

According to one embodiment of the present invention, a printed strain gauge is provided. In one embodiment, the strain gauge is a thin-film conductive material printed onto an insulated surface, which in various embodiments is the painted or anodized surface of the seat pan. In one embodiment, the thin-film conductive material forms a resistor, and in another embodiment, the thin-film conductive material forms a Wheatstone bridge circuit sensitive to strain induced in the pan along two axes.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a seat showing force arrows representing the weight from an occupant;

FIG. 2 is a cross-sectional view of one embodiment of a seat;

FIG. 3 is a bottom view of one embodiment of a seat showing the strain gauges;

FIG. 4 is a schematic diagram of one embodiment of a strain gauge;

FIG. 5A is a plan view of one embodiment of a printed pattern of a strain gauge;

FIG. 5B is a plan view of another embodiment of a printed pattern of a strain gauge;

FIG. 6 is a cross-sectional view of one embodiment of making a connection to the strain gauge;

FIG. 7 is a cross-sectional view of another embodiment of making a connection to a strain gauge; and

FIG. 8 is a cross-sectional view of another embodiment of a strain gauge.

### DETAILED DESCRIPTION OF THE INVENTION

An apparatus for detecting and measuring the presence and weight of an object on a vehicle seat is disclosed. The object, in various embodiments is a person, such as a passenger or driver, or an inanimate object, such as a bag of groceries.

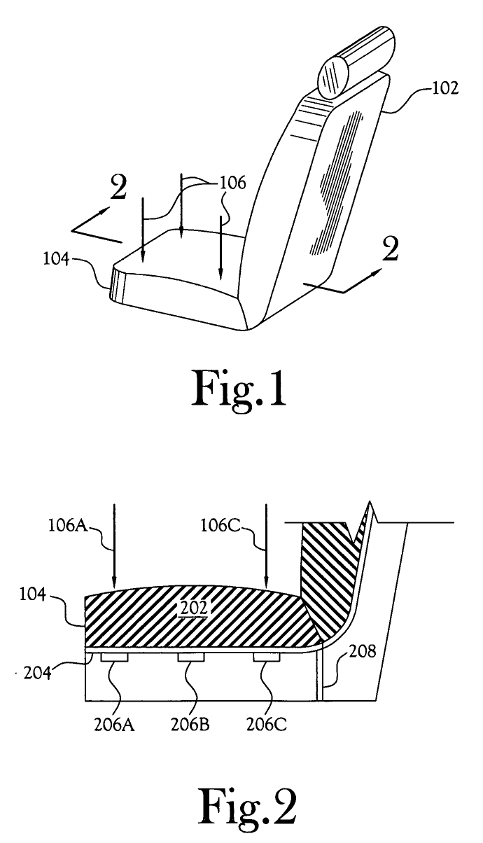

FIG. 1 illustrates a perspective view of a seat 104 showing force arrows 106 representing the weight from an occupant. The seat 104 includes a seat back 102 for supporting the back of the occupant. An occupant sitting in the seat 104 applies force 106 to the seat 104, and such force is represented by the force arrows 106 in FIG. 1.

FIG. 2 illustrates a cross-sectional view of one embodiment of a seat 104. The seat 104 includes a cushion 202 supported by a pan 204, which is supported by members 208 known in the art. Those skilled in the art will recognized that the pan 204, although illustrated as a member with a relatively flat cross-section, may have a curved surface with simple and/or compound curved sections without departing from the spirit and scope of the present invention. Further, the pan 204, in various embodiments, is shaped and has a thickness in selected areas so as to maximize the stress in selected positions of the pan 204, with the strain gauges 206 located at those selected positions. In the illustrated embodiment, three strain gauges 206A, 206B, 206C are visible. These strain gauges 206A, 206B, 206C are attached to the bottom of the pan 204. Each of the strain gauges 206A, 206B, 206C responds differently to the force 106 applied to the seat by the occupant.

For example, with an occupant sitting at the edge of the seat 104, the force 106A applied to the front of the seat 104 is greater than the force 106C applied to the rear of the seat 104 and the strain gauges 206A, 206B, 206C produce outputs indicating such a condition. Accordingly, the distribution of force 106 corresponding to the seated position of an occupant or other object in the seat 104 produces outputs from the strain gauges 206 indicating the position of the occupant or other object in the seat 104.

By positioning the gauges 206 at appropriate locations on the pan 204 or other supporting members of the seat 104, the seated weight and the position of the seated weight of the occupant is determined by measuring the strain at the selected points. The gauges 206 are positioned at locations that are subject to bending or stress caused by weight on the pan 204. For example, the seat pan 204 flexes and bends and experiences other stress, such as torsional and tensional, when a weight is applied to the seat 104. Maximum sensitivity is achieved by locating the gauges 206 at locations subject to maximum stress from weight applied to the seat 104.

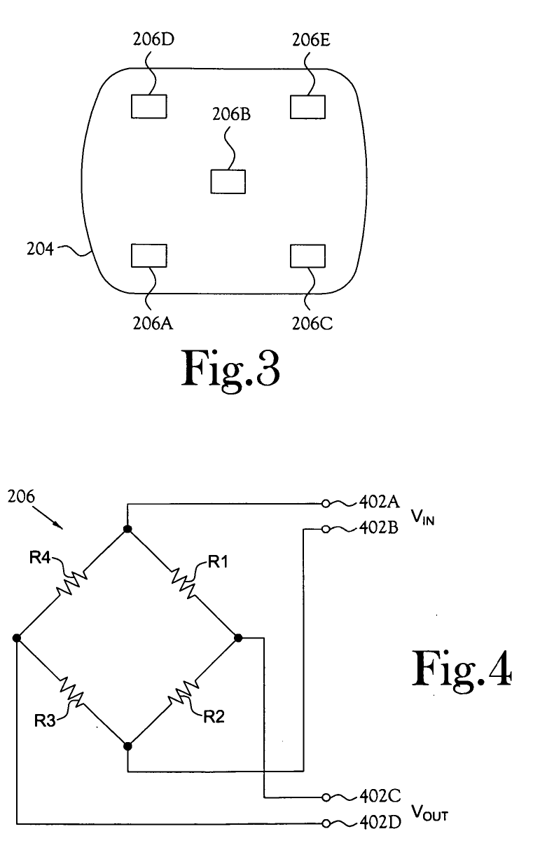

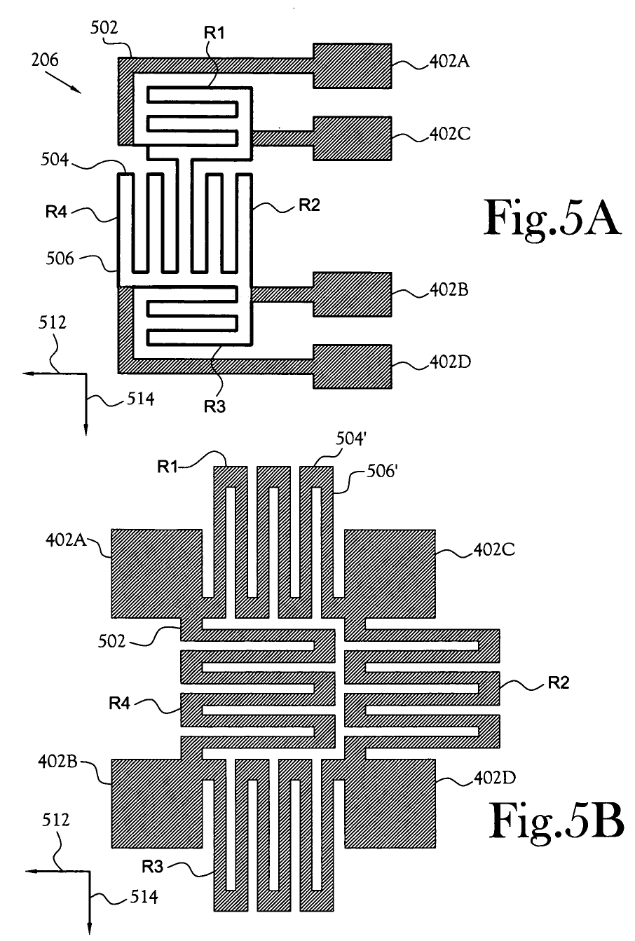

FIG. 3 illustrates a bottom view of one embodiment of a seat showing the strain gauges 206. In the illustrated embodiment, five strain gauges 206A, 206B, 206C, 206D, 206E are visible. These strain gauges 206A, 206B, 206C, 206D, 206E are attached to the bottom of the pan 204. The number and position of the strain gauges 206 are such as to provide the level of information desired. The more strain gauges 206 disposed on the pan 204, the more precise will be the information relating to occupant position. In one embodiment, three strain gauges 206 are positioned in line from the front to the rear of the pan 204. In other embodiments, other numbers of strain gauges 206 are used, such as the five strain gauges 206A, 206B, 206C, 206D, 206E in the illustrated embodiment. In one embodiment, the multiple strain gauges 206 are electrically connected by conductive traces printed on the pan 204. For example, referring to FIGS. 4, 5A, and 5B, the pads 402 for each strain gauges 206A, 206B, 206C, 206D, 206E are electrically connected by printed traces with low resistance. That is, the input Vin connections 402A, 402B for each strain gauge 206 are connected in parallel. In this manner, the number of electrical connections to the circuits printed on the pan 204 are minimized.

The illustrated embodiment shows a solid seat pan 204, however, the bending and/or other stresses caused by a weight on the seat 104 is increased by cutting slits, slots, holes, and other types of apertures in the seat pan 204. By increasing the bending and/or stress at specific areas of the pan 204 and locating the strain gauges 206 at those specific areas, the precision of weight detection and weight position or distribution on the seat 104 is increased.

FIG. 4 illustrates a schematic diagram of one embodiment of a strain gauge 206. In this embodiment, the strain gauge 206 is a Wheatstone bridge circuit that includes four resistors R1, R2, R3, R4 interconnected in a diamond configuration. The diamond configuration forms a Wheatstone bridge circuit with resistors R1, R3 opposite each other and resistors R2, R4 opposite each other. That is, resistors R1, R3 are a pair of opposite resistors and resistors R2, R4 are a pair of opposite resistors in the Wheatstone bridge.

An input voltage, or excitation voltage, Vin is applied between the top and bottom of the diamond (the junction of R1 and R4 shown as a connection point 402A and the junction of R2 and R3 shown as a connection point 402B) and the output voltage Vout is measured across the middle of the diamond (the junction of R1 and R2 shown as a connection point 402C and the junction of R3 and R4 shown as a connection point 402D). When the output voltage Vout is zero, the bridge is said to be balanced.

In various embodiments, one or more of the resistors R1, R2, R3, R4 of the bridge is a resistive transducer used as a strain gauge. The other resistors R1, R2, R3, R4 of the bridge that are not resistive transducers are simply completion resistors with resistance equal to that of the resistive transducer. As the resistance of one of the resistors R1, R2, R3, R4 changes the previously balanced bridge becomes unbalanced, which causes a voltage Vout to appear across the middle of the bridge. The change in resistance that causes the induced voltage is measured and converted to obtain the amount of strain being experienced by the resistive transducer. In the embodiment in which all the resistors R1, R2, R3, R4 of the bridge are resistive transducers, the bridge has the advantage of being insensitive to thermal expansion or contraction.

Oftentimes, when fabricating a bridge circuit, the individual resistance values of the resistors R1, R2, R3, R4 varies such that the bridge is not in balance. In one embodiment, the resistors R1, R2, R3, R4 are balanced by adding another resistor in parallel with one or more of the resistors R1, R2, R3, R4 such that the output Vout is zeroed. In another embodiment, one or more of the resistors R1, R2, R3, R4 are trimmed to set the resistors R1, R2, R3, R4 to the proper value and achieve balance. In one embodiment the resistors R1, R2, R3, R4 are trimmed by cutting or removing a portion of the traces 504, 506 to change the resistance. In still another embodiment, the bridge 206 is operated unbalanced and the circuit that monitors the bridge 206 output Vout measures the change from the steady state output voltage with no load on the seat 104. As a load 106 is put on the seat 104, the circuit measures the change in output Vout to determine the measured stress.

FIG. 5A illustrates a plan view of one embodiment of a printed pattern of a strain gauge 206. In this embodiment, a thin-film conductive material is printed with thin traces 504, 506 such that the resistors R1, R2, R3, R4 have a specified resistance and the strain gauge 206 connects to pads corresponding to the connection points 402. The pads 402A, 402B, 402C, 402D are connected to the resistors R1, R2, R3, R4 by printed traces 502 that are wider; therefore, the wide traces 502 have a lower resistance and are less susceptible to strain induced changes. In one embodiment, the printed strain gauge 206 has traces 502, 504, 506 that are between 0.0001 and 0.010 inches thick.

The traces 502, 504, 506 and the pads 402 are printed on an insulated material. In one embodiment, the strain gauge 206 is printed directly on the pan 204, which has been treated to have an insulating layer on the surface. Such insulating layers include, but are not limited to, anodization, paint, and insulting ink. In various such embodiments, the strain gauge 206 is printed or painted directly on an anodized or painted surface of the pan 204. In another embodiment, the strain gauge 206 is printed or painted on a resilient flexible substrate that is affixed to the pan 204. In still another embodiment, the seat pan 204 itself is fabricated of an insulating material and the strain gauge 206 is printed or painted directly on the surface of the pan 204. In various embodiments, the thin-film conductive material is printed on the pan 204 or other supporting member by pad printing, screen printing, ink jet, or other methods of applying a thin-film material to a surface.

When weight is applied to the seat 104, such as when an occupant sits, the pan 204 flexes a small amount. The flexing of the pan 204 causes the surface dimensions of the pan 204 to change however slightly. The strain gauge 206, because it is adhered to the surface of the pan 104, experiences these dimensional changes. The printed resistors R1, R2, R3, R4 are subject to tension or compression, depending upon whether the dimensional changes are positive or negative.

In the illustrated embodiment, two opposing resistors R1 and R3 are oriented along a first axis 512 parallel to the direction of maximum strain, and the other two opposing resistors R2 and R4 are oriented normal to that axis 512 along a second axis 514. The embodiment illustrated in FIG. 5 is a full bridge circuit. Accordingly, any strain measured along the first axis causes the resistance of R1 and R3 to change. Because R1 and R3 are opposite, equal changes to both R1 and R3 accentuates the change in the output voltage Vout. Likewise, any strain measured along the second axis causes the resistance of R2 and R4 to change in the opposite direction due to the effects of the Poisson's ratio.

The resistors R1, R2, R3, R4 are printed such that they have traces 506 with a substantially longer length that is parallel to an axis 512, 514 and a shorter length that is parallel to the normal axis 514, 512. In this manner, each resistor R1, R2, R3, R4 is more sensitive to strain along its major axis 512, 514 than its minor axis 514, 512.

In the embodiment illustrated in FIG. 2, strain gauges 206 are affixed to the bottom surface of the pan 204. Greater sensitivity is achieved by placing a strain gauge 206 on opposite sides of the pan 204. For example, for a beam member that is subjected to bending, one side of the member is in tension stress and the other side is in compression stress. If two of the strain gauge resistors R1, R3 or R2, R4 (located on opposite sides of the Wheatstone bridge) are on one side of the member and the other two gauge resistors R2, R4 or R1, R3 are attached to the opposite side of the member, the greatest sensitivity to measuring force or strain is achieved. In this configuration, the resistors R1, R2, R3, R4 are oriented along a parallel axis. The great sensitivity is due to the voltage difference between the current paths being at a maximum for a given stress or strain. Alternately, if all four sensing resistors R1, R2, R3, R4 are placed on one side of the beam, the resistors R1, R2, R3, R4 are arranged to maximize the sensitivity for measuring force or strain. To do this, the first set of resistors R1, R3 or R2, R4 (that are located on opposite sides of the bridge) are aligned in the direction of maximum strain. The second set of two resistors R2, R4 or R1, R3 are aligned in a direction 90 degrees from the first set of resistors. In this manner, the first set of resistors R1, R3 or R2, R4 is subjected to the maximum strain. Because of the Poisson's ratio of the material, the second set of resistors R2, R4 or R1, R3 are subjected to a strain that is approximately 30% of the first set of resistors and the direction of the strain of the second set of resistors is in the opposite direction. Accordingly, in one embodiment considering only the bending forces, one point on the surface of the pan 204 is subject to local compression and the opposite side of the pan 204 is subject to local tension. With one pair of resistors R1, R3 positioned on the top surface of the pan 204 and the other pair of resistors R2, R4 positioned opposite on the bottom surface of the pan 204, the pairs of resistors R1, R2, R3, R4 win be affected in an opposing manner, thereby resulting in a greater output voltage Vout change for a specified weight applied to the seat 104. The connection between the resistors R1, R2, R3, R4 on the opposite sides of the pan 204, in various embodiments, is achieved by conductive members passing through openings in the pan 204 or by conductive ink applied to a path from one side to the other.

FIG. 5B illustrates a plan view of another embodiment of a printed pattern of a strain gauge 206. In this embodiment, a thin-film conductive ink is printed with thin traces 504′, 506′ such that the resistors R1, R2, R3, R4 have a specified resistance and the strain gauge 206 connects to pads corresponding to the connection points 402. The pads 402A, 402B, 402C, 402D are connected to the resistors R1, R2, R3, R4 by printed traces 502 that are wider; therefore, the wide traces 502 have a lower resistance and are less susceptible to strain induced changes.

Although the traces 502, 504, 506, 504′, 506′ are illustrated in the two figures as having differing widths, those skilled in the art will recognize that the actual width of the 502, 504, 506, 504′, 506′ depends upon the desired resistance value and desired overall dimensions of the strain gauge 206. In the embodiment illustrated in FIG. 5B the short trace 504′ for each resistor R1, R2, R3, R4 is wider than the long trace 506′; thereby ensuring that any stress effects normal to the long trace 506′ are minimized because the short trace 504′, by being wider, has less resistance per linear length than the longer trace 506′.

FIG. 6 illustrates a cross-sectional view of one embodiment of making a connection to the strain gauge 206. A leaf spring 608 bears against a conductive surface 606 that is placed in contact with the pad 402. The conductive surface 606, in various embodiments, is a silver plated or otherwise conductive material soldered, glued, or otherwise adhered to the pad 402. The conductive surface 606 provides wear resistance and provides a good electrical contact between the leaf spring 608 and the pad 402. In another embodiment, the leaf spring 608 bears directly against the pad 402. Electrical continuity to the pad 402 of the strain gauge 206 through the leaf spring 608 is accomplished, in various embodiments, by a brush, bushing, or other means for making electrical contact to the leaf spring 608.

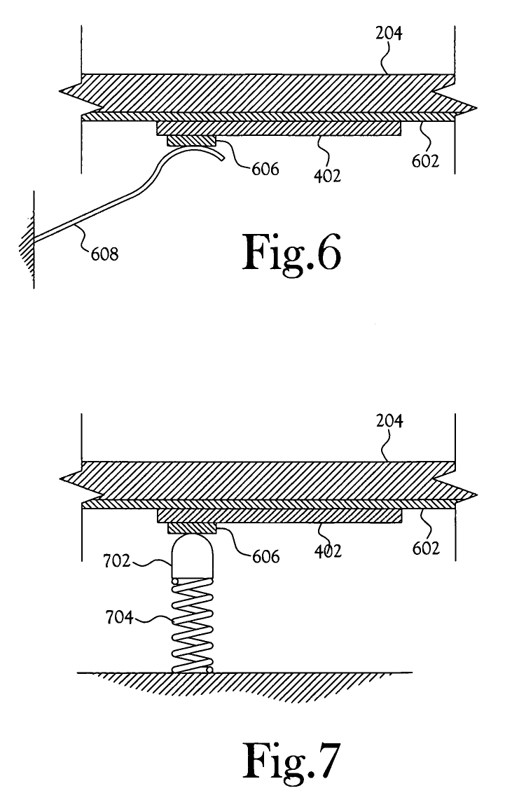

FIG. 7 illustrates a cross-sectional view of another embodiment of making a connection to a strain gauge 206. A contact plunger 702 contacts the conductive surface 606 that is placed in contact with the pad 402. The contact plunger 702 is forced against the conductive surface 606 by a spring 704. Electrical continuity to the pad 402 of the strain gauge 206 through the contact plunger 702 is accomplished, in various embodiments, by a brush, bushing, or other means for making electrical contact to the contact plunger 702 or the spring 704.

In another embodiment, the spring 704 makes direct contact with the pad 402 without using a contact plunger 702. In the illustrated embodiment, the spring 704 is a helical spring that applies pressure to the pad 402.

FIGS. 6 and 7 illustrate various embodiments of making electrical connections to the strain gauge 206. In still another embodiment, the electrical connections to the strain gauge 206 are made by using a conductive adhesive to secure conductors to the pads 402 of the strain gauge 206. In one such embodiment, a conductive epoxy is used to make the electrical connections to the pads 402. Such a connection results in a noise free connection.

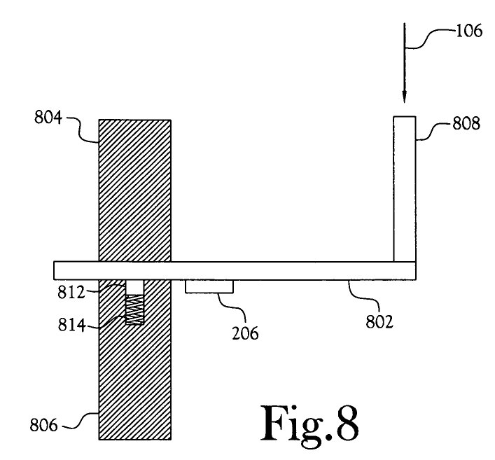

FIG. 8 illustrates a cross-sectional view of another embodiment of a strain gauge 206. In this embodiment, no part of the strain gauge 206 is used to provide structural support for the seat 104. Rather, this embodiment allows for the measurement of stress or movement of a structural component without itself becoming a structural element.

In the illustrated embodiment, a cantilevered beam 802 is fixed between two supports 804, 806 and a strain gauge 206 is affixed to one surface of the cantilevered beam 802. The free end of the cantilevered beam 802 has an operating member 808 to which a force 106 is applied, thereby causing the beam 802 to flex with the strain gauge 206 detecting the force 106. The member 808 is, in various embodiments, any type of connection to another object that allows movements of the object to be transferred to the beam 802. In another embodiment, the force 106 is applied directly to the beam 802. The force 106 in this embodiment is the force caused by a structural member of the seat 104 moving in response to an object being placed on the seat.

The cantilevered beam 802 in the illustrated embodiment is a flat member with a length substantially greater than its width and thickness. In other embodiments, the cantilevered beam 802 has a shape that allows the beam 802 to bend or flex in response to a force 106 applied to the end of the beam 802 or operating member 808.

In the illustrated embodiment, electrical connections to the strain gauge 206 are made by a contact plunger 812 and a spring 814 inside a channel or other opening in one of the two supports 806. In other embodiments, electrical connections to the strain gauge 206 are made as illustrated in FIGS. 6 and 7.

The apparatus includes various functions. The function of directly measuring stress on a member is implemented, in one embodiment, by a strain gage 206 directly affixed to a seat support member, such as a pan 204 or a cantilevered beam 802. The strain gage 206 includes at least one trace 504, 506 of a thin film conductive material forming a resistor that is attached to a member 204, 802 that is subject to a bending force or other stress. For a member 204, 802 that is conductive, the at least one trace 504, 506 is insulated from the seat support member 204, 802 by an insulated coating between the trace 504, 506 and the seat support member 204, 802.

From the foregoing description, it will be recognized by those skilled in the art that a printed strain gauge 206 has been provided. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, I claim:

1. An apparatus for detecting a weight and position of an object in a vehicle seat, said apparatus comprising:
a seat member providing structural support of at least a portion of the vehicle seat, said seat member subject to a stress when the object is on the vehicle seat;
an insulated coating on a selected area of said seat member; and
a strain gauge affixed to said insulated coating on said seat member in a location subject to said stress, said strain gauge including four traces of a thin-film conductive material in contact with said insulated coating, each of said four traces having a selected resistance, each of said four traces interconnected to form a Wheatstone bridge circuit, said strain gauge including a plurality of pads for making electrical connection to said strain gauge;
whereby said strain gauge is sensitive to said stress.

2. The apparatus of claim 1 wherein each of said four traces has a serpentine pattern with a majority of said thin-film conductive material positioned parallel to a major axis.

3. The apparatus of claim 1 wherein two of said four traces forming a first pair of opposite resistors for said Wheatstone bridge circuit have a major axis oriented normal to a major axis of a second pair of opposite resistors formed from a remaining two of said four traces.

4. The apparatus of claim 1 wherein two of said four traces forming a first pair of opposite resistors for said Wheatstone bridge circuit are positioned on a first surface of said member and a second pair of opposite resistors formed from a remaining two of said four traces are positioned on a second surface of said member opposite said first pair of opposite resistors.

5. The apparatus of claim 1 further including a plurality of spring members, each one of said plurality of spring members in elastic contact with one of said plurality of pads whereby a plurality of electrical connections are made to said Wheatstone bridge circuit.

6. The apparatus of claim 1 further including a plurality of spring members and a plurality of contact plungers, each one of said plurality of spring members in elastic contact with one of said plurality of contact plungers, each one of said plurality of contact plungers in electrical contact with one of said plurality of pads whereby a plurality of electrical connections are made to said Wheatstone bridge circuit.

7. The apparatus of claim 1 wherein said seat member is a seat pan.

8. The apparatus of claim 1 wherein said insulated coating includes at least one of the group including an anodized coating, a layer of paint, and a thin-film non-conductive material.

9. An apparatus for detecting a weight and a position of an object in a vehicle seat, said apparatus comprising:
a member subject to a stress when the object is on the vehicle seat; and
a first strain gauge affixed to said member, said first strain gauge subject to said stress, said first strain gauge including at least one trace of a thin-film conductive material applied directly to said member, each of said at least one trace having a selected resistance, said first strain gauge including a plurality of pads for making electrical connection to said strain gauge;
whereby said first strain gauge detects said stress of said member, thereby sensing the weight of the object on the vehicle seat.

10. The apparatus of claim 9 further including a second strain gauge wherein said second strain gauge is electrically connected to said first strain gauge by at least one printed trace having a low resistance.

11. The apparatus of claim 9 wherein said first strain gauge includes a first trace positioned on a first surface of said member and a second trace positioned on a second surface opposite said first trace, said first trace and said second trace electrically connected.

12. The apparatus of claim 9 wherein said member has a surface, at least a portion of said surface being an insulator, said thin-film conductive material in direct contact with said insulator.

13. The apparatus of claim 9 wherein said member includes an insulated coating covering at least a portion of a surface of said member, said thin-film conductive material applied over said insulated coating.

14. The apparatus of claim 9 wherein said thin-film conductive material is insulated from said member.

15. The apparatus of claim 9 wherein said at least one trace has a major axis.

16. The apparatus of claim 9 wherein each of said at least one trace has a serpentine pattern with a majority of said thin-film conductive material parallel to a major axis.

17. The apparatus of claim 9 wherein said at least one trace numbers four traces, each of said four traces interconnected to form a Wheatstone bridge circuit.

18. The apparatus of claim 9 wherein said member is one of a cantilevered beam and a seat pan.

19. The apparatus of claim 9 wherein said member is a seat pan and said seat pan has a selected shape and thickness that increases said stress in a selected area of said member where said strain gauge is affixed.

20. The apparatus of claim 9 wherein said member provides structural support to the vehicle seat and carries at least a portion of a load of the vehicle seat.

21. The apparatus of claim 9 further including a plurality of spring members, each one of said plurality of spring members in elastic contact with one of said plurality of pads whereby a plurality of electrical connections are made to said strain gauge.

22. The apparatus of claim 9 further including a plurality of spring members and a plurality of contact plungers, each one of said plurality of spring members in elastic contact with one of said plurality of contact plungers, each one of said plurality of contact plungers in electrical contact with one of said plurality of pads whereby a plurality of electrical connections are made to said strain gauge.

23. The apparatus of claim 9 further including a plurality of electrical conductors each one of which is fixed to one of said plurality of pads whereby a plurality of electrical connections are made to said first strain gauge.

24. An apparatus for detecting a weight and a position of an object in a vehicle seat, said apparatus comprising:
a member subject to a stress when the object is on the vehicle seat;
a circuit means for directly measuring said stress on said member.

25. An apparatus for detecting a weight and position of an object in a vehicle seat, said apparatus comprising:
a member subject to a stress when the object is on the vehicle seat; and
a strain gauge affixed to said member, said strain gauge subject to said stress, said strain gauge including four traces of a thin-film conductive material applied to said member, each of said four traces having a selected resistance, each of said four traces interconnected to form a Wheatstone bridge circuit, said strain gauge including a plurality of pads for making electrical connection to said strain gauge;
whereby said strain gauge detects said stress of said member, thereby sensing the weight of the object on the vehicle seat.

26. The apparatus of claim 25 wherein two of said four traces forming a first pair of opposite resistors for said Wheatstone bridge circuit are positioned on a first surface of said member and a second pair of opposite resistors formed from a remaining two of said four traces are positioned on a second surface of said member opposite said first pair of opposite resistors.

27. The apparatus of claim 25 wherein each of said four traces has a serpentine pattern with a majority of said thin-film conductive material applied parallel to a major axis.

28. The apparatus of claim 25 wherein two of said four traces forming a first pair of opposite resistors for said Wheatstone bridge circuit have a major axis oriented normal to a major axis of a second pair of opposite resistors formed from a remaining two of said four traces.

29. The apparatus of claim 25 wherein said member has a surface, at least a portion of said surface being an insulator, said conductive thin film in direct contact with said insulator.

30. The apparatus of claim 25 wherein said thin-film conductive material is insulated from said member.

31. The apparatus of claim 25 wherein said member is one of a cantilevered beam and a seat pan.

32. The apparatus of claim 25 wherein said member is a seat pan and said seat pan includes apertures increasing said stress in a selected area of said member where said strain gauge is affixed.

33. The apparatus of claim 25 wherein said member provides structural support to the vehicle seat and carries at least a portion of a load of the vehicle seat.

34. An apparatus for detecting a weight and position of an object in a vehicle seat, said apparatus comprising:
a member subject to a stress when the object is on the vehicle seat, said member being a seat pan; and
a first strain gauge affixed to said member, said first strain gauge subject to said stress, said first strain gauge insulated from said member;
whereby said first strain gauge detects said stress of said member, thereby sensing the weight of the object on the vehicle seat.

35. The apparatus of claim 34 wherein said first strain gauge includes four traces of a thin-film conductive material applied directly to said member, each of said four traces having a selected resistance, each of said four traces interconnected to form a Wheatstone bridge circuit, said first strain gauge including a plurality of pads for making electrical connection to said strain gauge.

36. The apparatus of claim 34 wherein said seat pan has a selected shape and thickness that increases said stress in a selected area of said member where said first strain gauge is affixed.

37. The apparatus of claim 34 further including a second strain gauge and a third strain gauge positioned substantially along an axis oriented front to rear of the vehicle seat whereby said first, second, and third strain gauges provide information in which a position of the object on the vehicle seat is determined.
